(19) United States
(12) Patent Application Publication
(10) Pub. No.: US 2009/0214696 A1
(43) Pub. Date: Aug. 27, 2009

(54) Lycopene Incorporation Into Egg Yolks

(76) Inventors: Elizabeth A. Koutsos, Davis, CA (US); Jacob B. Olson, Santa Clara, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/918,371

(22) PCT Filed: Jan. 24, 2006
(86) PCT No.: PCT/US2006/002287

§ 371 Date: Jan. 30, 2009

Related U.S. Application Data
(60) Provisional application No. 60/671,262, filed on Apr. 13, 2005.

(51) Int. Cl. A23K 1/18; A23L 1/32

(52) U.S. Cl. 426/2; 426/614

(57) ABSTRACT

The present invention includes an egg comprising lycopene, methods of producing eggs comprising feeding poultry with standard ingredients supplemented with an amount of lycopene effective to be deposited in the egg yolk, and methods of consuming an egg in a human diet comprising consuming, in a human diet, an egg wherein the egg comprises lycopene.

### FIELD OF THE INVENTION

The invention relates to incorporation of dietary lycopene by hens into egg yolk for the purpose of supplementing human diets with lycopene.

### DESCRIPTION OF THE RELATED ART

Lycopene has several biological functions that are associated with reduced cancer risk. For instance, research has shown that lycopene has antioxidant properties that lower the oxidative damage done to DNA in cancer cells, specifically prostate cancer cells (Stacewicz-Sapuntzakis M. and Bowen P. 2005 Biochemistry and Biophysics 1740:202-205; Wertz K. et al. 2004 Biochemistry and Biophysics 430:127-134). Lycopene slows cell cycle progression by down-regulating proteins important in cell growth (Wertz K. et al. 2004 Biochemistry and Biophysics 430:127-134). Gap-junction communication is increased by lycopene, helping to control cell proliferation (Campbell J. K. et al. Journal of Nutrition 134:3486S-3492S). Previous research with lutein, also an oxygenated carotenoid, has demonstrated that bioavailability of lutein is greater when consumed as part of egg than as a component of vegetables (i.e., spinach) or as a supplement (Chung H. et al. 2004 Journal of Nutrition 134:1887-1893).

### SUMMARY OF THE INVENTION

The present invention includes an egg comprising lycopene.

In another aspect, the present invention includes an egg obtained from a chicken comprising lycopene.

The invention also includes methods of producing eggs comprising feeding poultry with standard ingredients supplemented with an amount of lycopene effective to be deposited in the egg yolk.

The invention further provides methods of consuming an egg in a human diet comprising consuming, in a human diet, an egg wherein the egg comprises lycopene.

The invention also provides a food composition comprising, as a food ingredient, a whole egg, a liquid egg, or an egg yolk comprised of lycopene, in particular a food composition suitable for human consumption.

### BRIEF DESCRIPTION OF THE DRAWINGS

Figure A. Structures of common carotenoids found in human serum and tissues. Lycopene lacks the β-ionone ring end structure of β-carotene and lutein and does not contain any hydroxyl groups. Cis-geometrical isomers are formed by the introduction of a cis double bond in the polyene chain. all-trans and 5-cis-lycopene are the two most common isomers found in human and animal tissues.

FIG. 1. Dietary lycopene levels affect yolk color score. White Leghorn laying hens were fed one of four dietary levels of lycopene for 15 days. Diet 1=0 mg lycopene; Diet 2=65 mg lycopene/kg diet; Diet 3=257 mg lycopene/kg diet; Diet 4=650 mg lycopene/kg diet. Eggs were gathered on the last day and Roche yolk color scores were assessed. Diet 2, 3 and 4 had a significantly darker pigmentation compared to diet 1 (p<0.05).

FIG. 2. Dietary lycopene levels affect yolk lycopene concentration. White Leghorn laying hens were fed one of four dietary levels of lycopene for 15 days. Diet 1=0 mg lycopene; Diet 2=65 mg lycopene/kg diet; Diet 3=257 mg lycopene/kg diet; Diet 4=650 mg lycopene/kg diet. Eggs were gathered on the last day and analyzed for lycopene by HPLC. Diet 1 had no detectable levels of lycopene, diets 3 and 4 had significantly higher levels of lycopene compared to diet 2 (p<0.05). ND=Not Detectable.

FIG. 3. Regression equation predicting yolk lycopene concentration based upon dietary lycopene level. Lycopene (μg/g yolk)=2.125+(0.00893*diet lycopene (mg/kg diet))−(0.00003*(diet lycopene (mg/kg diet)−243)²). R²=0.84; p<0.001.

FIG. 4. Effect of diet on Roche Yolk Color Score.

FIG. 5. Effect of dietary lycopene on egg yolk pigmentation.

FIG. 6. Effect of dietary lutein on plasma lutein.

FIG. 7. Effect of dietary lycopene on egg yolk pigmentation.

FIG. 8. Effect of diet on Roche Yolk Color Score.

FIG. 9. Effect of diet on yolk lutein concentration.

FIG. 10. Effect of diet on yolk lycopene concentration.

### DETAILED DESCRIPTION OF THE PREFERRED EMBODIMENT

There is considerable interest in the beneficial properties of lycopenes in human health. Humans can not synthesize carotenoids de novo and must attain these micronutrients exclusively through their diets. Although the necessity for β-carotene as the precursor of vitamin A has been recognized for many years, it is lycopene, a carotenoid that lacks provitamin A activity, that has attracted the most attention of late. Lycopene is the pigment principally responsible for the deep-red color of ripe tomato fruits and tomato products. The consumption of tomatoes and tomato products containing lycopene has been shown to be associated with decreased risk of chronic diseases such as cancer and cardiovascular diseases. Many have attributed the health benefits of lycopene to its antioxidant properties (lycopene quenches singlet oxygen almost twice as well as β-carotene does), although other mechanisms of lycopene action are possible. For example, modulation of intercellular communication, hormonal and immune system changes, and alteration of metabolic pathways may also be involved.

The present invention is of an egg comprising lycopene, a method of producing same and the consumption of same in human diet.

In the present invention, lycopene is generally deposited in the yolk of an egg.

The egg according to the present invention comprises lycopene in an amount of about 0.005-0.5 mg/g of yolk, preferably at least about 0.005, 0.01, 0.02, 0.03, 0.04, or 0.05 mg/g yolk, or at least about 0.06 mg, 0.07 mg, 0.08 mg, 0.09 mg or 0.1 mg/gram yolk, or at least about 0.2, 0.3, 0.4, or 0.5 mg/g yolk.

As used herein, the term “lycopene-enriched egg” refers to an egg that contains a lycopene concentration in the range from greater than zero to about 0.5 mg/g of yolk following dietary ingestion of lycopene by an egg-laying hen.

As used herein, the term “whole egg” indicates the liquid content of an egg that is the whole shell egg plus the shell.

As used herein, the term “liquid egg” indicates the liquid content of an egg, that is the whole shell egg minus the shell.

As used herein, the term “egg yolk” indicates the yellow, usually spherical part of an egg of a bird that is surrounded by the albumen and consists primarily of protein and fat.

As used herein, the term “egg white” indicates the protective gelatinous substance surrounding the yolk consisting mainly of the protein albumin dissolved in water.

A large whole egg is approximately 59 g, the corresponding liquid egg is approximately 50 g and the corresponding egg yolk is approximately 17 g. The amount of edible lycopene present in the egg yolk of the present invention is preferably at least about 0.005-0.5 mg/g yolk.

Lycopene, the red pigment in tomatoes, is a C40, open-chain hydrocarbon carotenoid (Figure A). Rotation of any of its 11 conjugated double bonds allows for the formation of a number of cis-geometrical isomers, which may have implications regarding the biological action of this carotenoid.

Lycopenes may be selected, e.g., among: all-trans-lycopene, 5-cis-lycopene, 6-cis-lycopene, 7-cis-lycopene, 8-cis-lycopene, 9-cis-lycopene, 10-cis-lycopene, 11-cis-lycopene, 12-cis-lycopene, 13-cis-lycopene, 14-cis-lycopene, 15-cis-lycopene, 16-cis-lycopene, 17-cis-lycopene, 18-cis-lycopene, 19-cis-lycopene, 20-cis-lycopene, 21-cis-lycopene, 22-cis-lycopene, 23-cis-lycopene, 24-cis-lycopene, 25-cis-lycopene and 26-cis-lycopene, and lycopenes with multiple cis-conformations at any of carbon atoms 5-26.

The present invention comprises lycopene-enriched eggs and methods of making and using lycopene-enriched eggs that are enriched with any one of, or combinations of all-trans- and/or cis-lycopene isomers.

Although lycopene exists in human and animal tissues mainly as cis-isomers, lycopene is found in most food sources primarily as the all-trans isomer (80-97% all-trans). In humans, cis-lycopene isomers are preferentially absorbed compared with the all-trans isomer. Investigators have identified five forms of lycopene, all-trans being the predominant form, and four cis-isomers including 5-cis-lycopene, 9-cis-lycopene, 13-cis-lycopene, and 15-cis-lycopene accounting for the most lycopene.

The sources of the lycopene may be natural sources (e.g., tomatoes, red palm oil, watermelon, papaya, pink grapefruit and pink guava) or lycopene can be purified from natural sources or it can be manufactured synthetically. Lycopene can be obtained commercially. For example, DSM Nutritional Products markets lycopene under the tradename of redivivo™ in water suspension (WS) that consists of violet-brown, free-flowing particles (beadlets) that contain lycopene finely dispersed in a cornstarch-coated matrix of fish gelatin, sucrose and corn oil. dl-α-Tocopherol and ascorbyl palmitate are added as antioxidants. DSM Nutritional Products also provides lycopene in fluid suspension (FS) and in tablet grade (TG) form. Lycopene may be obtained from other commercial vendors such as BASF under the registered name Lycovit®, etc.

Failed attempt: Laying hens were fed a diet supplemented with crumbled tomatoes as a source of lycopene. When the absorption spectrum of the egg yolk was examined, no trace of lycopene was found indicating that the lycopene was not absorbed as such in the yolk. In this study, it was concluded that lycopene was not deposited in eggs because it was transformed into other carotenoids or xanthophylls (Suarez, 1969 Poult Sci 48:733-735).

The egg according to the present invention comprises advantageously additional edible antioxidants.

These antioxidants may be selected, e.g., among: synthetic antioxidants which have been found to protect: vitamin E, omega-3 fatty acids, Carotenoids, poly-unsaturated fatty acids (PUFA), etc., such as butylated hydroxytoluene (BHT), ethoxyquin (EMQ), N,N′-diphenyl-p-phenylenediamine (DPPD), Ionol, Diludin, Digisan, Tana, Kurasan, etc.; Phenolos and Flavonoids from herbs and plants, e.g., sage, rosemary, green and black tea, etc.; or pure forms like Hydroxyflavone, Galanin, Quercetine, Catechines, ubiquinol, etc.; Selenium; vitamin C (As Ascorbic Acid or Ascorbyl Esters); mixtures of the above; etc.

All said antioxidants should be within the recommended dietary allowance (RDA) and not exceed twice the amount allowed by RDA in one egg. The amount of the antioxidant differs according to the kind of antioxidant combinations thereof utilized.

Said antioxidants are fed to the chicken as part of the standard mixtures or of water, advantageously as part of a premix.

A preferred egg comprises at least about 0.05-5 mg lycopene per 59 grams of whole egg; per 50 grams of liquid egg; or per 17 grams of egg yolk.

Optionally a preferred egg of the invention comprises at least about 0.05, 0.06, or 0.07 mg, optionally at least about 0.08 mg, 0.09 mg, 0.1 mg, 0.2 mg, 0.3 mg, 0.4 mg, or 0.5 mg, and preferably at least about 0.6 mg, 0.7 mg, 0.8 mg, 0.9 mg, 1 mg, 2 mg, 3 mg, 4 mg, or 5 mg of lycopene per 59 grams of whole egg; per 50 grams of liquid egg; or per 17 grams of egg yolk.

The sources of lycopene comprise all-trans-lycopene, a cis-lycopene isomer, or a mixture of all-trans-lycopene and at least one cis-lycopene isomer.

The present invention consists also of a method for producing chicken eggs (as defined above) which consists of feeding chickens with a standard feed mixture supplemented with lycopene in an amount ascertained that the eggs so produced contain the target amounts of said lycopene.

Said lycopene may be part of the standard food mixture; added as part of a premix, in water or separately.

Should other antioxidants (e.g., other carotenoids and vitamin E) be present, they are fed to the hen in adequate amounts.

The standard grain based food mixture is advantageously a milo, barley, rye oat, wheat, rice corn, soybean, etc., based food mixture.

As used herein, the term “standard ingredients” refers to a basal diet fed to hens that meets the nutrient requirements for laying hens (see, National Research Council 1994 Nutrient Requirements of Poultry, Ninth Revised Edition, National Academy Press, Washington, D.C.)

The method according to the present invention preferably comprises feeding hens with standard ingredients supplemented with lycopene.

The method of the invention comprises feeding hens with standard ingredients supplemented with lycopene in an amount that is at least about 50 mg, 100 mg, 150 mg, 200 mg, 250 mg, 300 mg, 350 mg, 400 mg, 450 mg, 500 mg, 550 mg, 600 mg or 650 mg/kg diet, or at least about 700, 750, 800, 850, 900, 950 mg/kg diet, or at least about 1000, 1500, 2000, 2500, 3000, 3500, 4000, 4500 or 5000 mg/kg of diet, or at least about 6, 7, 8, 9, 10, 20, 30, 40, 50, 60, or 70 g/kg diet.

The diet of standard ingredients supplemented with lycopene may optionally be further supplemented with other edible antioxidants; the antioxidant content of the egg not exceeding 2 times the amount allowed by RDA/egg.

The lycopene fed to the hen should not exceed the amount indicated above, preferably it should not exceed the LD₅₀. Preferable it should be at a level that can be determined by those of ordinary skill in the art not to be toxic. For example, acute lycopene toxicity occurs at blood levels greater than the LD₅₀ of 3000 mg lycopene/kg body weight in mice and at blood levels greater than the LD₅₀ of 10,000 mg/kg body weight in rats.

Another aspect of the present invention is related to a food composition comprising, as a food ingredient, the whole egg, the liquid egg or the egg yolk of the eggs according to the invention, especially a food composition suitable for human consumption, including a functional food.

The methods of the present invention include the feeding of poultry laying hens with amounts of lycopene effective to be deposited in the egg yolk in an amount of at least about 0.005 mg, 0.01 mg, 0.02 mg, 0.03 mg, 0.04 mg, 0.05 mg, 0.1 mg, 0.2 mg, 0.3 mg, 0.4 mg or 0.5 mg of edible lycopene which is generally deposited in the yolk per gram of yolk.

Poultry is the class of domesticated fowl (birds) used for food or for their eggs. These most typically are members of the orders Galliformes (such as chickens and turkeys), and Anseriformes (waterfowl such as ducks and geese). Domesticated poultry consist of many breeds of chicken, duck, turkey, geese, and swan.

Breeds of Chickens include (e.g., Ac, Ancona, Andalusian, Appenzell Bearded Hen, Appenzell Pointed Hood Hen, Araucana, Aseel, Australorp, Bandara, Baheij, Brahmas, Barnevelders, Buckeye, Buttercup, Campine, Catalana, Chantecler, Cochin, Cornish, Crevecoeur, Cubalaya, Delaware, Dominiques, Dorking, Dutch Bantam, Faverolles, Frieslands, Frizzle, Gallus Inauris, Gimmizah, Golden Montazah, Hamburgs, Holland, Houdan, Java, Jersey Giant, Jungle Fowl, Green, Gray, La Fleche, Lakenvelder, Lamona, Langshan, Leghorn, Malay, Matrouh, Minorca, Modern Game, Naked Neck (Turken), New Hampshire Red, Old English Game, Orpington, Plymouth Rock, Polish, Red Cap, Rhode Island Red, Silkie Bantam, Silver Montazah, Styrian, Sultan, Sumatra, Sussex, Swiss Hen, White-Faced Black Spanish, and Wyandottes.)

Breeds of turkey include (e.g., Black, Bourbon, Bronze, Narragansett, Royal Palm, Slate, and White).

Breeds of duck include (e.g., Call, Cayuga, Crested, Khald Campbell, Muscovy, Orpington, Pekin, Pommeranian Duck, Rouen, and Runner.)

Breeds of geese include (e.g., African, Chinese, Brown, White, Diepholz, Embden, Egyptian, Pilgrim, and Toulouse.)

Other types of poultry include Guinea Fowl, the Black Swan, and ostrich.

### Enrichment of Egg Yolks with Lycopene

The purpose of this trial was to examine the ability of the laying hen to deposit lycopene into the egg yolk for the purpose of supplementing human diets with additional lycopene. Control egg-laying hens were fed a 100 gram per bird basal diet for 15 days described in Table 1. Test hens were fed the basal diet supplemented with varying amounts of lycopene.

TABLE 1
Diet composition for basal diet fed to laying hens.

| Nutrient Name | Amount |
|---|---|
| Metabolizable energy | 2967.8 Kcal/kg |
| Crude protein | 18.1% |
| Lys | 1.01% |
| Met | 0.49% |
| Met + Cys | 0.82% |
| Crude fat | 5.8% |
| Ca | 3.90% |
| P (non-phytate) | 0.52% |
| P (total) | 0.64% |

Data were examined for main effect of dietary treatment by GLM using one way analysis of variance (ANOVA, JMP, SAS, Cary, NC). When the main effect was significant (p < 0.05), Tukeys LSM was used to determine differences between means. Finally, yolk lycopene concentrations were examined using regression analysis to determine optimal yolk lycopene incorporation relative to dietary lycopene levels (JMP, SAS, Cary, NC).

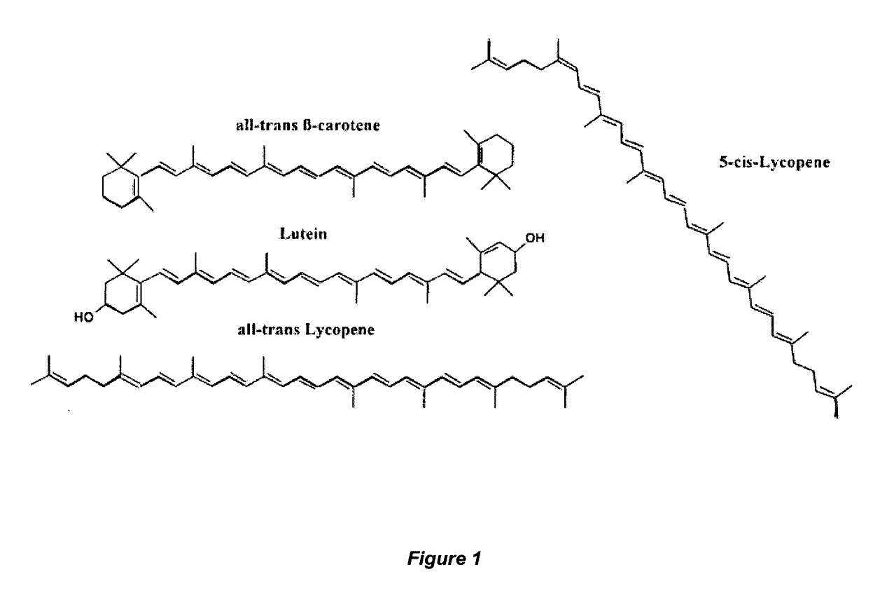

After 15 days of feeding the assigned diets, egg yolk color was significantly affected by dietary lycopene concentration (p<0.01), in which eggs from hens fed 65, 257 or 650 mg lycopene/kg diet had significantly greater yolk color score than that of eggs from hens fed 0 mg dietary lycopene (p<0.05 for each, FIG. 1). An increased color score is indicative of a darker yellow pigmentation in the egg yolk.

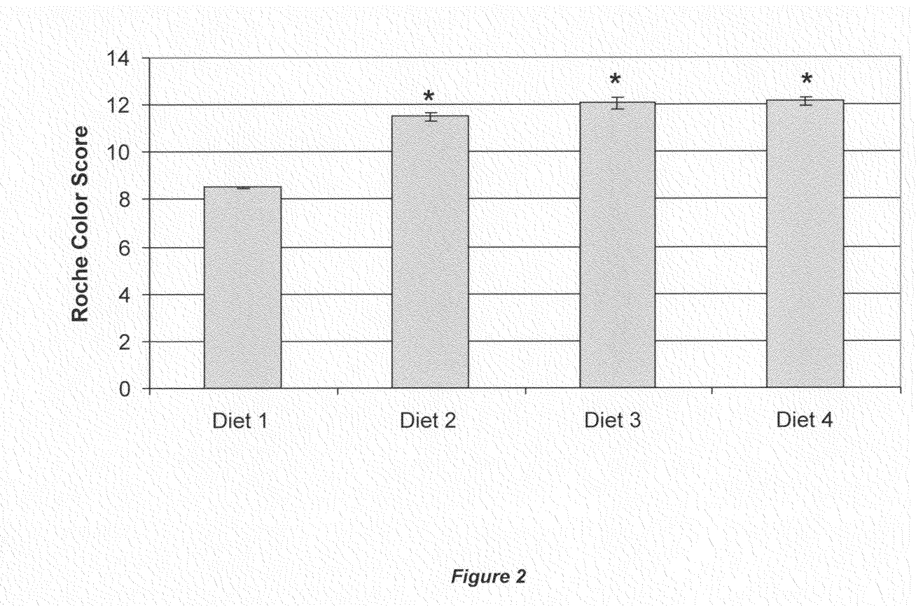

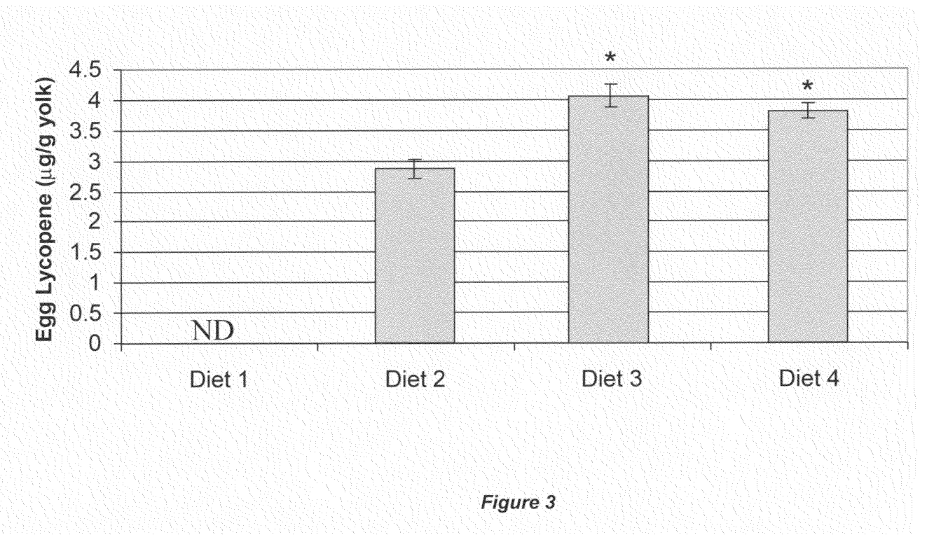

HPLC analysis of egg yolks also showed a significant effect of diet (p<0.01). Eggs from hens fed 0 mg lycopene had no detectable lycopene levels, while eggs from hens fed 257 or 650 mg lycopene/kg diet had significantly greater lycopene levels as compared to those fed 65 mg lycopene/kg diet (p<0.05 for each, FIG. 2). Finally, regression analysis shows that optimal lycopene incorporation into egg would occur at dietary levels of 420 mg/kg diet (FIG. 3).

### CONCLUSIONS

This trial confirms previous trials showing that lycopene is absorbed by laying hens. Yolk color was increased by feeding any level of dietary lycopene. HPLC analysis demonstrates that higher levels of dietary lycopene enhance egg yolk lycopene incorporation.

Based upon HPLC data, the maximal concentration of yolk lycopene would correspond with 0.08 mg lycopene/17 g egg yolk (large egg). In comparison, a medium, ripe, uncooked tomato contains approximately 2.57 mg lycopene. Thus the egg yolk will contain approximately 0.03% of lycopene in a tomato. Based upon previous research with another carotenoid, lutein, absorbance from egg is approximately 2.12 times that of the absorbance from vegetable sources (Chung H. et al. 2004 Journal of Nutrition 134:1887-1893).

### EXAMPLE 1

The California Polytechnic State University Animal Care and Use Committee approved all protocols. Using a completely randomized design, first-cycle White Leghorn (Hyline W36 strain, 23 wks old) laying hens from the Cal Poly University flock were randomly assigned to one of three dietary lycopene levels. Birds were fed a basal diet formulated to meet or exceed all nutrient requirements for laying hens (National Research Council 1994 Nutrient requirements of Poultry, Ninth Revised Edition, National Academy Press, Washington, D.C.) plus either 0, 65, 257, or 650 mg lycopene/kg diet; the lycopene provided was the all-trans isomer. Dietary levels were chosen based on the amount of lycopene contained in an uncooked 100 g tomato, as well as data concerning the absorption of lutein by laying hens (Leeson, S. and Caston, L. 2004 Poultry Science 83:1709-1712). Lycopene was supplied in a 5% powder form attached to a gelatin molecule. In order for lycopene to be absorbed from this source, water (60° C.) was used to disperse the lycopene prior to dietary addition.

Hens were housed in commercial-type cages (n=3 cages/diet, 4 birds/cage, 135 sq. inches/bird) with ad libitum access to water. Hens were fed their assigned diets at 100 g/bird*day for 15 days. Eggs were gathered daily, and after 15 days of dietary feeding, analysis of egg lycopene levels were completed by Roche color score (a standardized set of color swatches corresponding to a number from 1-15) and by HPLC analysis (DSM International, Basel Switzerland).

### EXAMPLE 2

Lycopene is a carotenoid with potential anti-cancer functions. Specifically, epidemiological data suggests that lycopene consumption is associated with reduced prostate cancer risk. Additionally, it has been demonstrated for other carotenoids (lutein) that bioavailability is greater in egg yolks than in supplements or plant-based sources. Therefore, second cycle laying hens (Hyline W36) were examined for their ability to absorb dietary lycopene and incorporate lycopene into egg yolks. A completely randomized design was used in which 3 levels of dietary lycopene (0, 1.0 and 5.7 mg/bird*day) or lycopene +lutein (5.7 mg lycopene+0.8 mg lutein/bird*day) were incorporated into the birds normal diet. Birds were housed in commercial cages with ad libitum access to water (n=3 cages/diet; 5 birds/cage), and were fed 120 g diet/bird*day. Using the Roche color fan, egg yolks had no detectable change in pigmentation after 18 d of feeding lycopene. There was no evidence of lycopene incorporation into egg yolks or plasma, however the diet containing lutein resulted in a significant increase in yolk lutein (p<0.05) but not plasma lutein (p=0.36). Future trials will examine increased dietary lycopene levels and routes of administration.

### Lycopene and Lutein Bioavailability

Lutein is more available in egg yolk compared to vegetables and dietary supplements (Chung H. et al. 2004 Journal of Nutrition 134:1887-1893). Lycopene has a similar structure to Lutein and may also be more available in products with high lipid content. Lutein is shown to prevent macular degeneration (Leeson, S. and Caston, L. 2004 Poultry Science 83:1709-1712). Lycopene is shown to prevent prostate cancer (Herzog A. 2005 FASEB J 19:272-274.). The purpose of this experiment was to examine the ability for a hen to absorb dietary lycopene and incorporate the lycopene into egg yolk.

### General Materials and Methods

Commercial laying hen diet (corn, soybean, from NuWest) was supplemented with lycopene and lutein (DSM). Second Cycle Hyline W36 Hens were housed in standard lay cages. Dependant Variables: Yolks and Plasma. Lipid Extraction was done as previously described (Koutsos at al. 2003 J Nutr 133:1132-1138). A UV/VIS spectrophotometer was use to measure absorbance at 464 nm for Lutein and 352 nm for Lycopene. For Studies 2 and 3, the Roche Colour Score was taken of egg yolks using a blind analysis. The following statistics were calculated: ANOVA for main effect of diet+days on diet and interactions and t-test for differences between means. Results were significant at p<0.05.

In Study 1, 5 hens were housed per cage and 3 cages were given treatment for 19 d on a diet at 120 g diet/bird*d. Diet 1: Negative Control; Diet 2: Negative Control+8 mg lycopene/kg diet; Diet 3: Negative Control+48 mg lycopenel/kg diet; Diet 4: Diet 3+6.5 mg Lutein/kg diet. There was no evidence of lycopene incorporation into egg yolk or plasma. Yolk lutein was increased by feeding lutein (Diet 4) (p<0.05). There was no increase in plasma lutein (p=0.36).

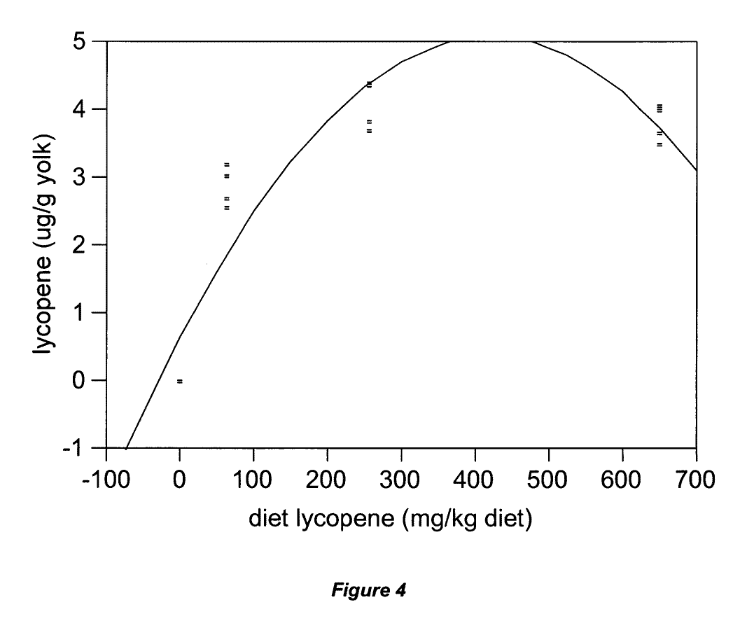

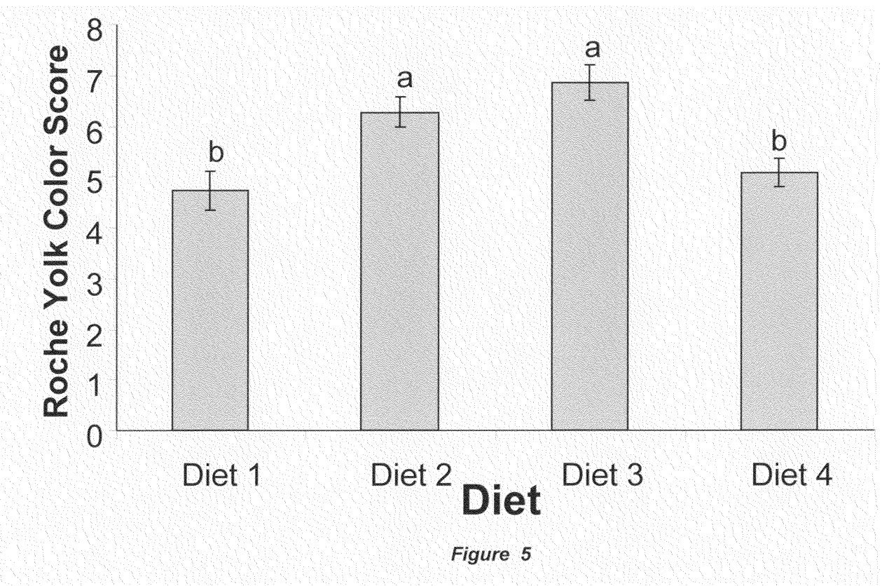

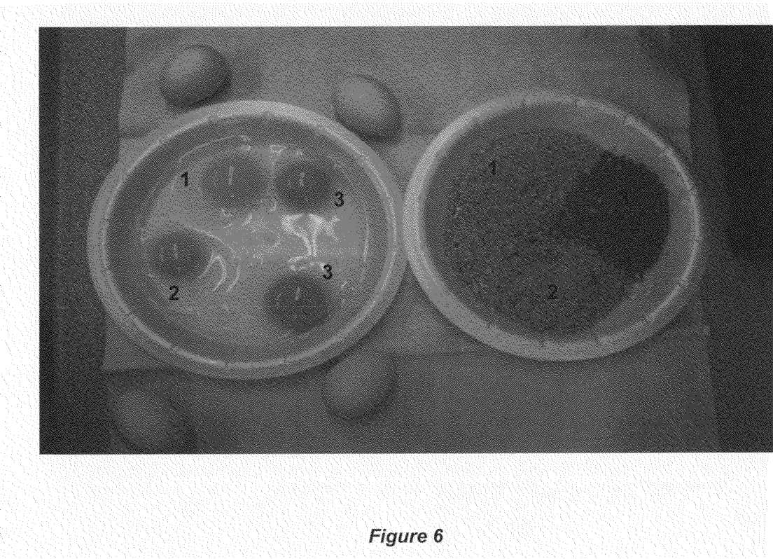

In Study 2, 5 hens were housed per cage and 3 cages were given treatment for 19 d on a diet at 100 g diet/bird*d. Lycopene and Lutein levels were increased and dispersed in H₂O: Diet 1: Negative Control+3000 ml H₂O; Diet 2: Negative Control+880 mg lycopene/kg diet +3000 ml H₂O; Diet 3: Negative Control+5140 mg lycopene/kg diet+3000 ml H₂O; Diet 4: Negative Control+7.8 mg Lutein/kg diet+3000 ml H₂O. The Roche Yolk Colour Fan was used (FIG. 4, 5). Dietary Lycopene (880 mg) showed 5140 mg>0 mg on the Roche Colour Fan (p<0.01). Dietary Lutein on the Roche colour fan showed no effect and days on diet had no effect on the Roche Colour Fan (p=0.06). Diet had no effect on Yolk Lutein and/or Lycopene (p>0.20 for all). Diet on Plasma lycopene had no effect (p=0.17). Plasma Lutein+Lycopene had no effect (p=0.07). Diet on Plasma Lutein: (p=0.04). Diet 2, 3>1, 4 (p<0.05) (FIG. 6).

In Study 3, 5 hens were housed per cage and 1 cage received treatment for 15 d on diet at 100 g diet/bird*d. Lycopene levels were increased and dispersed in H₂O: Diet 1: Negative Control+3000 ml H₂O; Diet 2: Negative Control+880 mg lycopene/kg diet+3000 ml H₂O; Diet 3: Negative Control+1285 mg lycopene/kg diet+3000 ml H₂O; Diet 4: Negative Control +2570 mg lycopene/kg diet+3000 ml H₂O; Diet 5: Negative Control+3855 mg lycopene/kg diet+3000 ml H₂O; Diet 6: Negative Control+5140 mg lycopene/kg diet+3000 ml H₂O; Diet 7: Negative Control+6425 mg lycopene/kg diet+3000 ml H₂O; Diet 8: Diet 5+7.8 mg Lutein/kg diet; Diet 9: Diet 7+7.8 mg Lutein/kg diet.

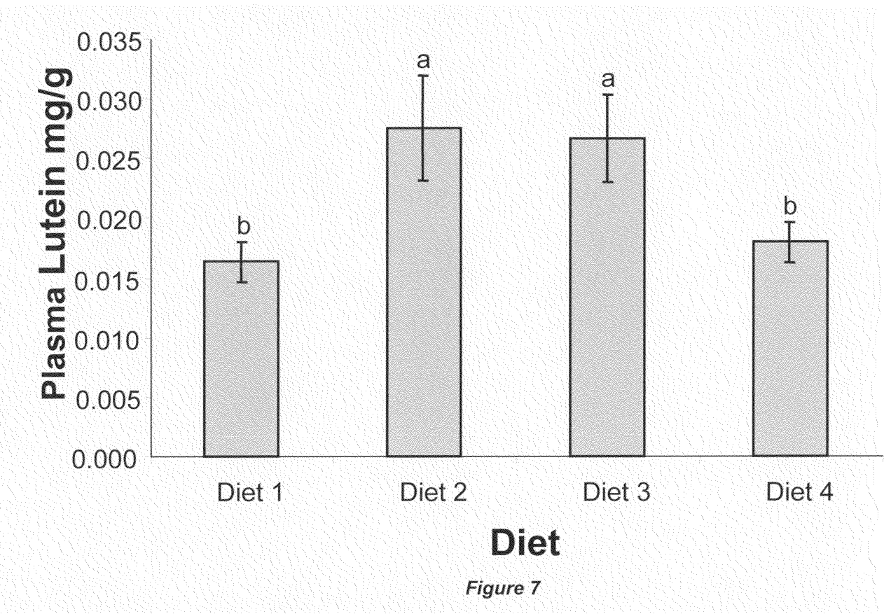

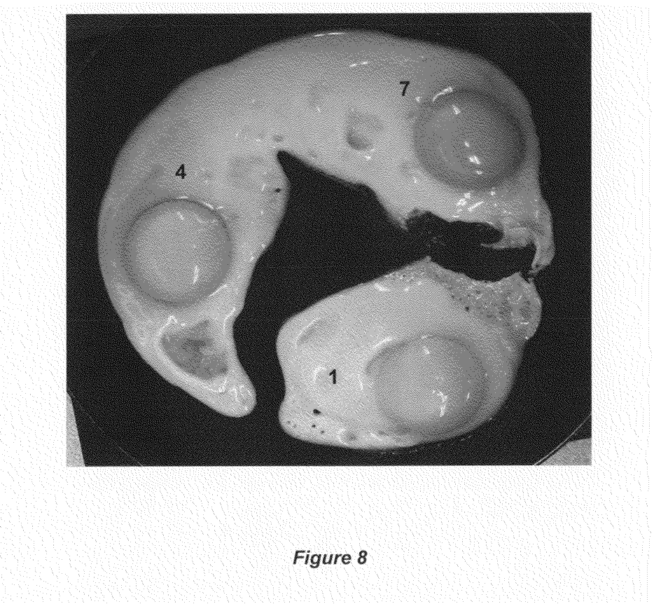

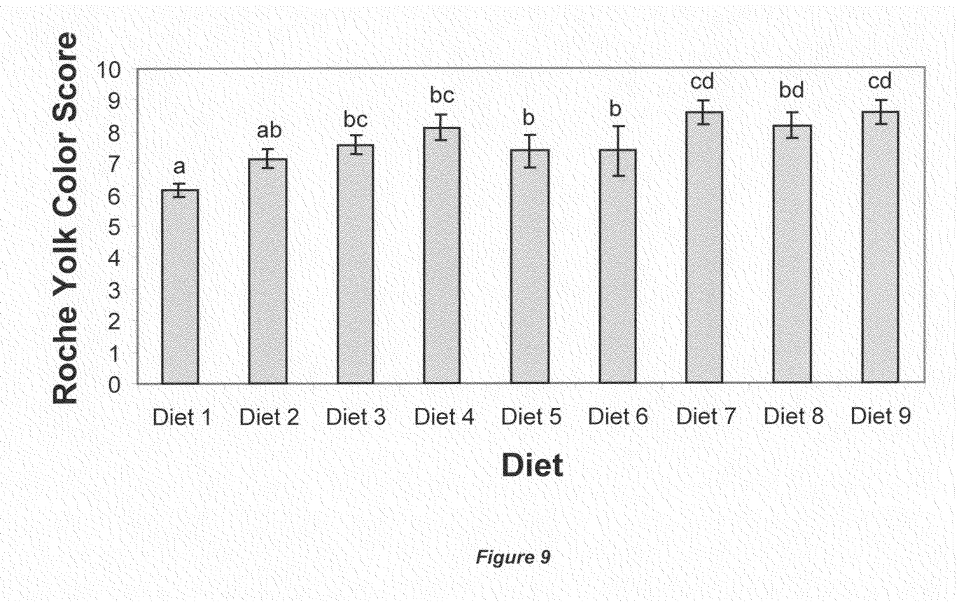

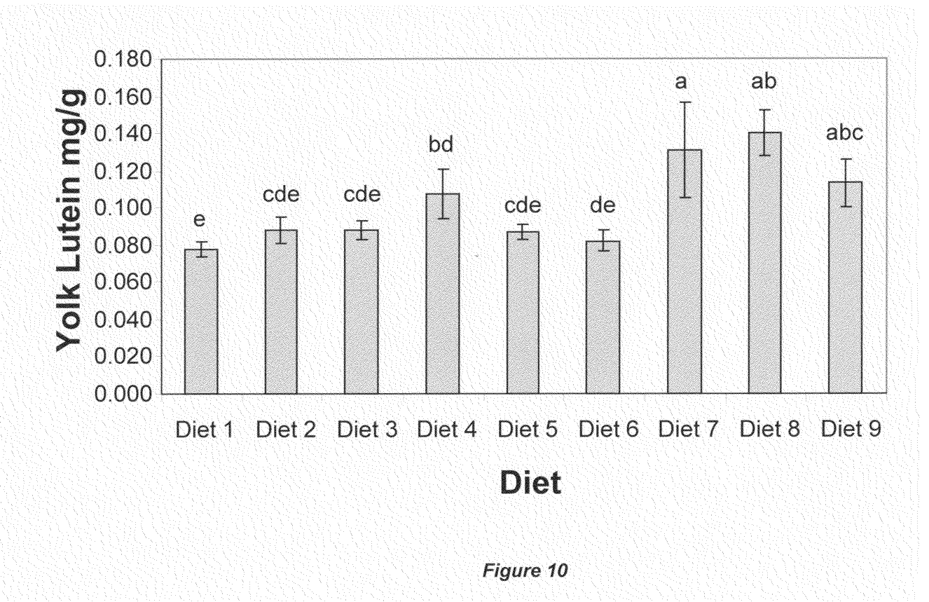

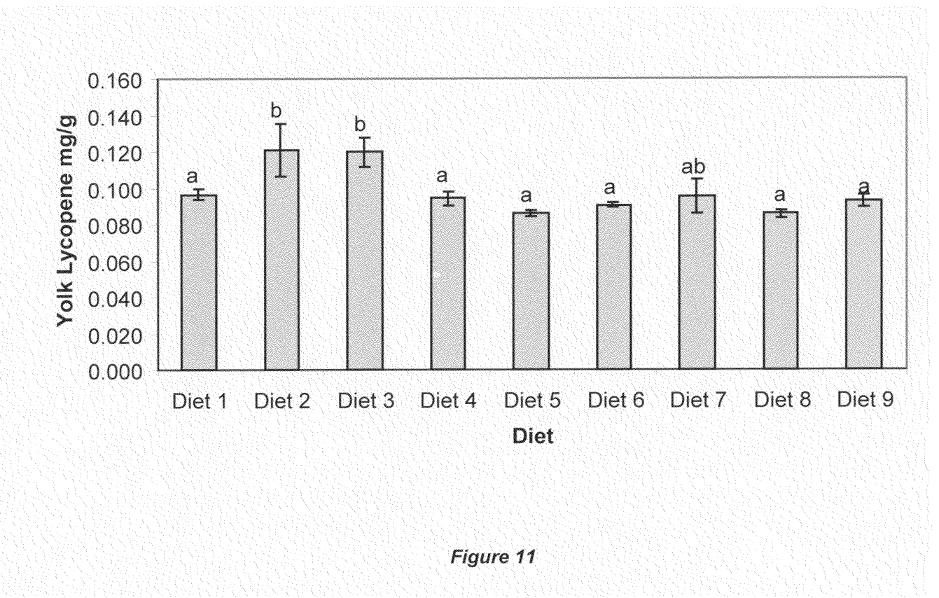

In Study 3, Plasma Lutein and/or Lycopene on diet had no effect (p>0.20). When analyzed by the Roche Yolk Colour Fan, Diet on Roche Score showed (p<0.01)(FIG. 7, FIG. 8). Days on Diet on Roche Score showed (p<0.01), Day 12, 15>4, 8 (p<0.05). Diet on Yolk Lutein+Lycopene had no effect (p=0.94). Diet on Yolk Lutein (p<0.01) (FIG. 9) Diet 4, 7, 8, 9>1 (p<0.05). Effect of Diet on Yolk Lycopene (p<0.01) (FIG. 10) Diet 2, 3>1, 4, 5, 6, 8, 9 (p<0.05).

### CONCLUSIONS

The Roche color scores show a consistent difference in yolk pigment between control diet and diets>1285 mg Lycopene. Yolk lycopene increased (determined spectrophotometrically) in diets with 880 mg to 1285 mg Lycopene. There was little to no incorporation of Lycopene into plasma however there was a significant increase of Lutein in the plasma. Thus there is a potential for Lycopene-enriched egg with proper dietary addition.

While the present invention has been described in some detail for purposes of clarity and understanding, one skilled in the art will appreciate that various changes in form and detail can be made without departing from the true scope of the invention. All figures, tables, and appendices, as well as patents, applications, and publications, referred to above, are hereby incorporated by reference.

1. An egg comprising lycopene.

2. An egg obtained from a chicken comprising lycopene.

3. The egg of claim 1 wherein the egg is a whole egg.

4. The egg of claim 1 wherein the egg is a liquid egg.

5. The egg of claim 1 wherein said lycopene is present in the amount of at least about 0.05-5 mg/egg.

6. The egg of claim 1 wherein said lycopene is present in the amount of at least about 0.1-2 mg/egg.

7. The egg of claim 1 wherein said lycopene is the all-trans isomer.

8. The egg of claim 1 wherein said lycopene is a cis isomer selected from the group consisting of 5-cis lycopene, 9-cis-lycopene, 13-cis-lycopene and 15-cis-lycopene.

9. A method of producing eggs comprising feeding poultry with standard ingredients supplemented with an amount of lycopene effective to be deposited in the egg yolk.

10. The method of claim 9 wherein said lycopene is dispersed in water prior to dietary addition.

11. The method of claim 9 wherein said lycopene is present in the amount of at least about 0.05-5 mg/egg.

12. The method of claim 9 wherein said lycopene is present in the amount of at least about 0.1-2 mg/egg.

13. The method of claim 9 wherein said lycopene is the all-trans isomer.

14. The method of claim 9 wherein said lycopene is a cis isomer selected from the group consisting of 5-cis lycopene, 9-cis-lycopene, 13-cis-lycopene and 15-cis-lycopene.

15. A method of consuming an egg in a human diet comprising consuming, in a human diet, an egg wherein the egg comprises lycopene.

16. The method of claim 15 wherein said lycopene is present in the amount of at least about 0.05-5 mg/egg.

17. The method of claim 15 wherein said lycopene is present in the amount of at least about 0.1-2 mg/egg.

18. The method of claim 15 wherein said lycopene is the all-trans isomer.

19. The method of claim 15 wherein said lycopene is a cis isomer selected from the group consisting of 5-cis lycopene, 9-cis-lycopene, 13-cis-lycopene and 15-cis-lycopene.

20. A food composition comprising, as a food ingredient, the whole egg, the liquid egg, or the egg yolk of claim 1, in particular a food composition suitable for human consumption.
